(19) United States
(12) Patent Application Publication
(10) Pub. No.: US 2009/0278889 A1
(43) Pub. Date: Nov. 12, 2009

(54) PRINT CONTROLLING METHOD AND RELATED PRINTER

(76) Inventors: Cheng-Lung Lee, Taipei City (TW); Po-Chin Yang, Tai-Nan City (TW); Sheng-Lung Tsai, Ping-Tung County (TW)

Correspondence Address: NORTH AMERICA INTELLECTUAL PROPERTY CORPORATION, P.O. BOX 506, MERRIFIELD, VA, 22116, US

(21) Appl. No.: 12/185,115

(22) Filed: Aug. 4, 2008

(30) Foreign Application Priority Data
May 12, 2008 (TW) 097117454

(51) Int. Cl. B41J 2/145

(52) U.S. Cl. 347/40

(57) ABSTRACT

A print controlling method is applied to a printer. The printer includes a plurality of nozzles, wherein each nozzle is respectively driven by one of a plurality of address lines. The print controlling method includes dividing the plurality of address lines into M groups, wherein M is a positive integer; and enabling the address lines belonging to one of the M groups to drive the corresponding nozzles during each slice period, wherein the address lines enabled at adjacent slice periods correspond to different groups.

### BACKGROUND OF THE INVENTION

1. Field of the Invention

The present invention relates to a print controlling method and related printer, and more particularly, to a print controlling method and related printer for improving print speed by using characteristics of a shingling mode to drive different nozzles at adjacent slice periods.

2. Description of the Prior Art

Ink-jet printers have become a popular print facility due to them providing high print quality at a reasonable price. In general, an ink-jet printer has one or more print heads, wherein each of the print heads includes a plurality of nozzles. In order to reduce the complexity of the driving circuit, the elements used for controlling the nozzles are arranged in a matrix and are respectively controlled by address lines (A-Line) and power lines (P-Line). Only when the address line and the power line are simultaneously enabled can the ink spout out of the corresponding nozzles. In general, the number of address lines and power lines increases as the number of nozzles increases. The address lines are enabled in order by the system to avoid driving all the nozzles at the same time, which further avoids exceeding a system workload.

Please refer to FIG. 1. FIG. 1 is a timing diagram of driving nozzles during a slice period according to the prior art. As shown in FIG. 1, two phase signals A and B with a 90-degree phase difference are generated by a code stripe having a black-and-white spaced in-between pattern. If a spacing of the black-and-white spaced in-between pattern of the code stripe is 1/150 inch, a spacing between variations of any one of the phase signals A and B is 1/600 inch and its transversal resolution is 600 dots per inch (dpi). As can be seen from FIG. 1, there are sixteen address lines A1-A16 and eight power lines P1-P8, wherein the address lines A1-A16 are enabled in order while the power lines P1-P8 are enabled depending on print demands. The power lines coupled to each address line may be enabled once after all the address lines A1-A16 have passed through a round, that is to say, all nozzles probably may be enabled once, and this is called a slice period. In other words, a slice period is equal to a time for passing through 1/600 inch.

As shown above, the address lines A1-A16 must be enabled in order during a slice period. However, when the number of the nozzles increases, the number of the address lines must be increased to control all the nozzles if the number of the power lines coupled to each address line is constant. Due to the number of address lines being increased, a slice period gets longer, which results in lowering the print speed of the whole system. Hence, how to improve the print speed of a printer without exceeding a system workload is an important topic in this field.

### SUMMARY OF THE INVENTION

It is one of the objectives of the present invention to provide a print controlling method and related printer, which drives different nozzles at adjacent slice periods to solve the abovementioned problems.

According to an exemplary embodiment of the present invention, a print controlling method applied to a printer is provided. The printer includes a plurality of nozzles arranged in a matrix, wherein each nozzle is driven by one of a plurality of address lines. The print controlling method includes dividing the plurality of address lines into M groups; and enabling the address lines belonging to one of the M groups to drive the corresponding nozzles during each slice period; wherein M is a positive integer and the address lines enabled at adjacent slice periods correspond to different groups.

According to another exemplary embodiment of the present invention, a printer is provided. The printer includes a plurality of nozzles arranged in a matrix, a nozzle driving circuit, and an ink controller. The nozzle driving circuit includes a plurality of address lines, wherein each of the plurality of address lines is respectively coupled to one of the plurality of nozzles for driving the corresponding nozzle. The ink controller is coupled to the plurality of address lines of the nozzle driving circuit and the plurality of nozzles. The ink controller includes a group allocating module and a group controlling module. The group allocating module is used for dividing the plurality of address lines into M groups, wherein M is a positive integer. The group controlling module is used for controlling the nozzle driving circuit to enable the address lines belonging to one of the M groups to drive the corresponding nozzles during each slice period, wherein the address lines enabled at adjacent slice periods correspond to different groups.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of driving nozzles during a slice period according to the prior art.

FIG. 2 is a diagram of a printer according to an embodiment of the present invention.

FIG. 3 is a flowchart of a print controlling method applied to a printer according to an exemplary embodiment of the present invention.

FIG. 4 is a diagram illustrating how to drive different nozzles at adjacent slice periods according to a first embodiment of the present invention.

FIG. 5 is a timing diagram showing an example of the driving sequence of the first pass of printing shown in FIG. 4.

FIG. 6 is a diagram illustrating how to drive different nozzles at adjacent slice periods according to a second embodiment of the present invention.

FIG. 7 is a timing diagram showing an example of the driving sequence of the preceding two passes of printing shown in FIG. 6.

FIG. 8 is a timing diagram showing another example of the driving sequence of the preceding two passes of printing shown in FIG. 6.

### DETAILED DESCRIPTION

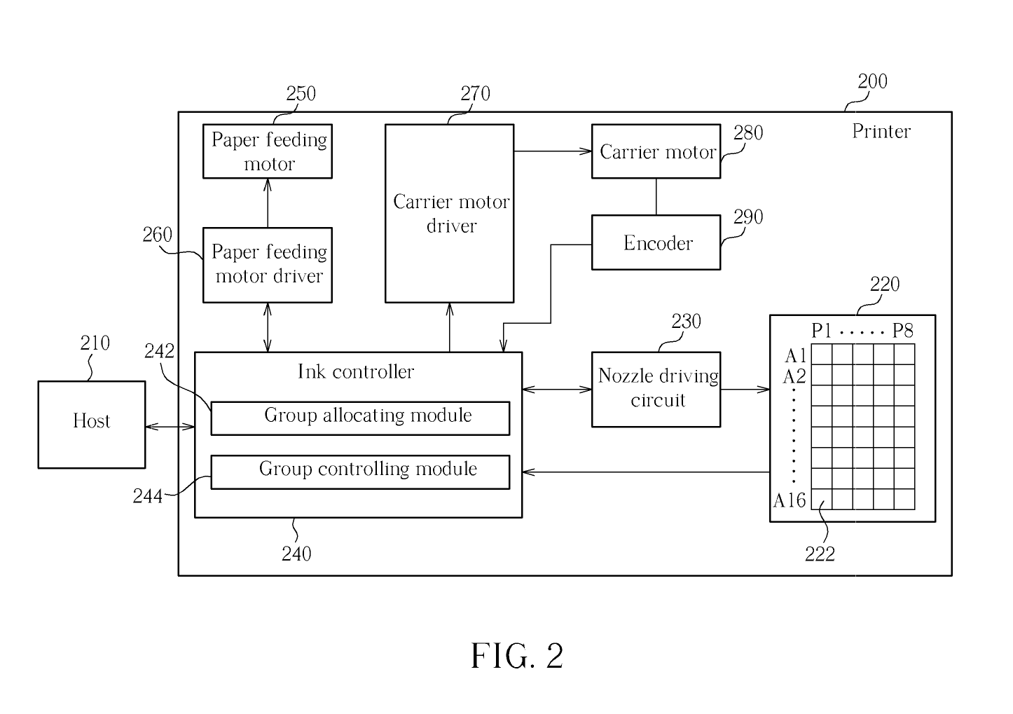

Please refer to FIG. 2. FIG. 2 is a diagram of a printer 200 according to an embodiment of the present invention. The printer 200 includes, but is not limited to, a plurality of nozzles 222, a nozzle driving circuit 230, an ink controller 240, a paper feeding motor 250, a paper feeding motor driver 260, a carrier motor 280, a carrier motor driver 270, and an encoder 290. The printer 200 is controlled by the ink controller 240, wherein print data is delivered to the printer 200 from a host 210. When the printer 200 prepares to print data, the ink controller 240 transmits the print data to the nozzle driving circuit 230. At this time, the ink controller 240 controls the paper feeding motor driver 260 to start the paper feeding motor 250 for feeding papers into the print area, and the carrier motor driver 270 then drives the carrier motor 280 to move the plurality of nozzles 222, wherein the moving speed and location of the nozzles can be detected by the encoder 290. Only when the nozzles 222 are moved to their target locations will the nozzles 222 be driven to spout ink.

Please keep referring to FIG. 2. In this embodiment, the plurality of nozzles 222 are arranged in a matrix 220 and are controlled by the address lines A1-A16 and the power lines P1-P8, wherein each nozzle is driven by one of the address lines A1-A16. The nozzle driving circuit 230 is coupled between the plurality of nozzles 222 and the ink controller 240 for enabling the address lines A1-A16 to drive the plurality of nozzles 222. The ink controller 240 is coupled to the nozzle driving circuit 230 and the plurality of nozzles 222. The ink controller 240 includes a group allocating module 242 and a group controlling module 244. The group allocating module 242 is used for dividing the address lines A1-A16 of the matrix 220 into M groups, wherein M is a positive integer, and for delimiting all the nozzles 222 related to each address line of each group into the same group to divide the plurality of nozzles 222 into M groups. For example, if M equals 2, all the nozzles 222 related to the address lines A1-A8 are delimited into a first group, and all the nozzles 222 related to the address lines A9-A16 are delimited into a second group. The group controlling module 244 controls the nozzle driving circuit 230 to drive the nozzles corresponding to one of the groups (the first group or the second group) during each slice period and to drive the nozzles corresponding to different groups at adjacent slice periods. For example, the nozzles belonging to the first group (i.e., the nozzles related to the address lines A1-A8) are driven during the first slice period, and the nozzles belonging to the second group (i.e., the nozzles related to the address lines A9-A16) are driven during the second slice period.

Please note that all the nozzles may be driven once after M slice periods go by. For example, if M equals 2, all the nozzles belonging to the first group and the second group (i.e., the address lines A1-A8 and A9-A16) may be driven once after two slice periods go by. Furthermore, the printer 200 can be a thermal bubble printer, but is not limited to this only and can be printers of another type.

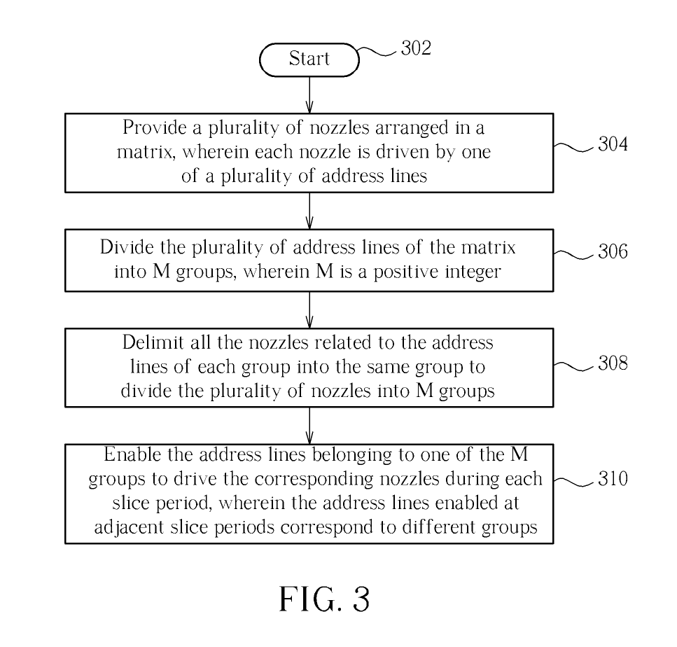

Please refer to FIG. 3. FIG. 3 is a flowchart of a print controlling method applied to a printer according to an exemplary embodiment of the present invention. Please note that the following steps are not limited to be performed according to the exact sequence shown in FIG. 3 if a roughly identical result can be obtained. The method includes, but is not limited to, the following steps:

Step 302: Start.

Step 304: Provide a plurality of nozzles arranged in a matrix, wherein each nozzle is driven by one of a plurality of address lines.

Step 306: Divide the plurality of address lines of the matrix into M groups, wherein M is a positive integer.

Step 308: Delimit all the nozzles related to the address lines of each group into the same group to divide the plurality of nozzles into M groups.

Step 310: Enable the address lines belonging to one of the M groups to drive the corresponding nozzles during each slice period, wherein the address lines enabled at adjacent slice periods correspond to different groups.

In the following description, how each element operates is described by collocating the steps shown in FIG. 3 and the elements shown in FIG. 2. In Step 304, the printer 200 provides the plurality of nozzles 222 arranged in a matrix 220, which are controlled by the address lines A1-A16 and the power lines P1-P8. In steps 306-308, the address lines A1-A16 of the matrix 220 is divided into M groups (such as 2, 4, or more groups) by the group allocating module 242 of the ink controller 240, wherein all the nozzles related to each address line of each group are delimited into the same group to divide the plurality of nozzles 222 into M groups. The group controlling module 244 then controls the nozzle driving circuit 230 to enable the address lines belonging to one of the M groups to drive the corresponding nozzles during each slice period, wherein the address lines enabled at adjacent slice periods correspond to different groups (Step 310).

Please note that the abovementioned steps are presented merely for describing applications of the present invention, and in no way should be considered to be limitations of the scope of the present invention. It will be obvious to those skilled in the art that the method can include other intermediate steps and appropriate modifications of the method may be made without departing from the spirit of the present invention.

In the following, some examples are taken for illustrating detailed operations of allocating groups and driving different nozzles at adjacent slice periods.

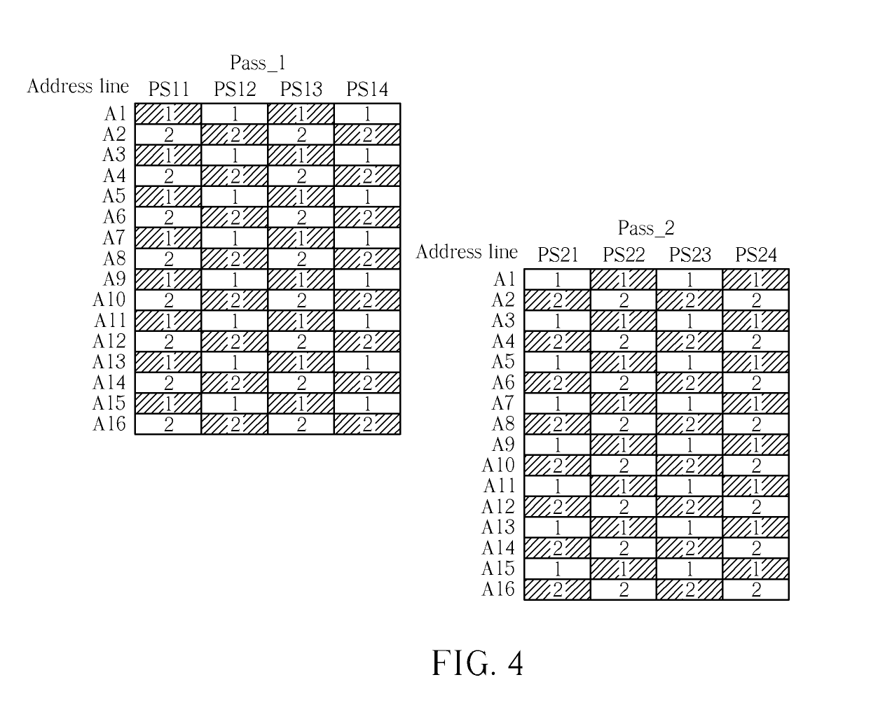

Please refer to FIG. 4. FIG. 4 is a diagram illustrating how to drive different nozzles at adjacent slice periods according to a first embodiment of the present invention. In this embodiment, M equals 2 and a 50% shingling mode with 600 dpi is used. Thus, printing of a certain area can be finished whenever two-pass printings pass through. As shown in FIG. 4, the two passes of printing are represented by Pass_1 and Pass_2, wherein each of the two passes of printing respectively includes four slice periods labeled by PS11-PS14 and PS21-PS24 respectively. After the print head completes one pass of printing, the print head is moved down a distance equaling one-half of the print head relative to its target object, such as the paper. The print area of the print head that the address lines A9-A16 correspond to during the first pass of printing Pass_1 is the same as the print area of the print head that the address lines A1-A8 correspond to during the second pass of printing Pass_2, which correspond to the same print area of the target object. Due to M equaling 2, the address lines A1-A16 of the matrix 220 are divided into two groups. In this embodiment, all the nozzles related to the odd address lines A1, A3, . . . , A15 are delimited into the first group, and all the nozzles related to the even address lines A2, A4, . . . , A16 are delimited into the second group. In the first pass of printing Pass_1, the nozzles belonging to the first group (i.e., the odd address lines A1, A3, . . . , A15) may be driven during the odd slice periods (i.e., PS11 and PS13) depending on practical demands, and the nozzles belonging to the second group (i.e., the even address lines A2, A4, . . . , A16) may be driven during the even slice periods (i.e., PS12 and PS14) depending on practical demands. In the second pass of printing Pass_2, the nozzles belonging to the second group (i.e., the even address lines A2, A4, . . . , A16) may be driven during the odd slice periods (i.e., PS21 and PS23) depending on practical demands, and the nozzles belonging to the first group (i.e., the odd address lines A1, A3, . . . , A15) may be driven during the even slice periods (i.e., PS22 and PS24) depending on practical demands. In other words, the nozzles belonging to different groups are driven at adjacent slice periods. All the nozzles may be driven once after two (M=2) slice periods go by.

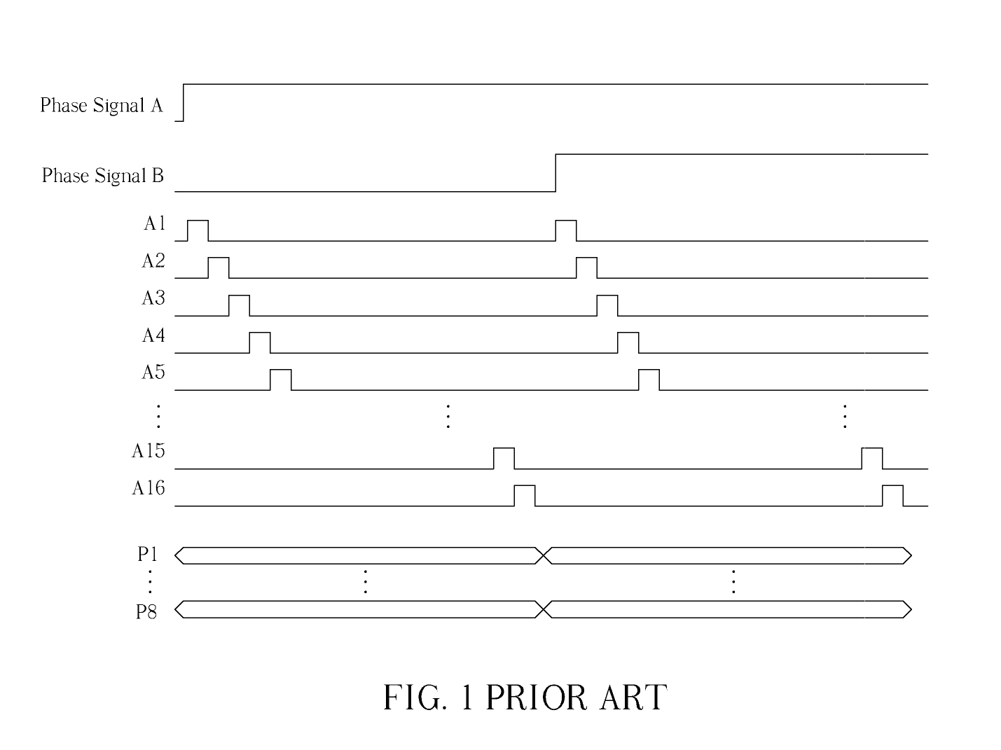

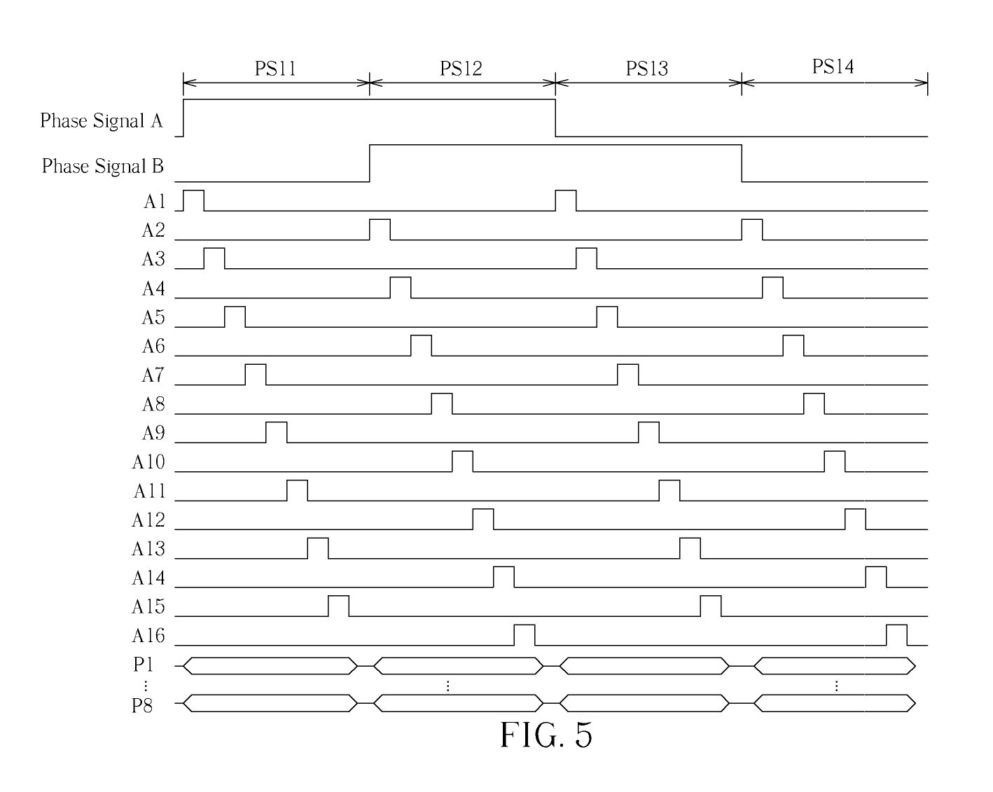

Please refer to FIG. 5. FIG. 5 is a timing diagram showing an example of the driving sequence of the first pass of printing Pass_1 shown in FIG. 4. There are sixteen address lines A1-A16 and eight power lines P1-P8, wherein the address lines A1-A16 are enabled in order while the power lines P1-P8 are enabled depending on print demands. The driving sequence for driving the address lines during the preceding four slice periods PS11, PS12, PS13 and PS14 are shown in FIG. 5. As can be seen from FIG. 5, only the nozzles belonging to the first group (i.e., the odd address lines A1, A3, . . . , A15) need to be driven during the odd slice periods (i.e., PS11 and PS13), and only the nozzles belonging to the second group (i.e., the even address lines A2, A4, . . . , A16) need to be driven during the even slice periods (i.e., PS12 and PS14). Compared with the timing diagram shown in FIG. 1, there are sixteen address lines of nozzles that need to be enabled during each slice period in FIG. 1 while there are eight address lines of nozzles that need to be enabled during each slice period in FIG. 5. For example, assuming that the time of the slice period in FIG. 1 equals T, thus the time of the slice period in FIG. 5 can be shortened to T/2. Therefore, the time of the slice period can be shortened to improve the print speed by adopting the print controlling method disclosed in the present invention.

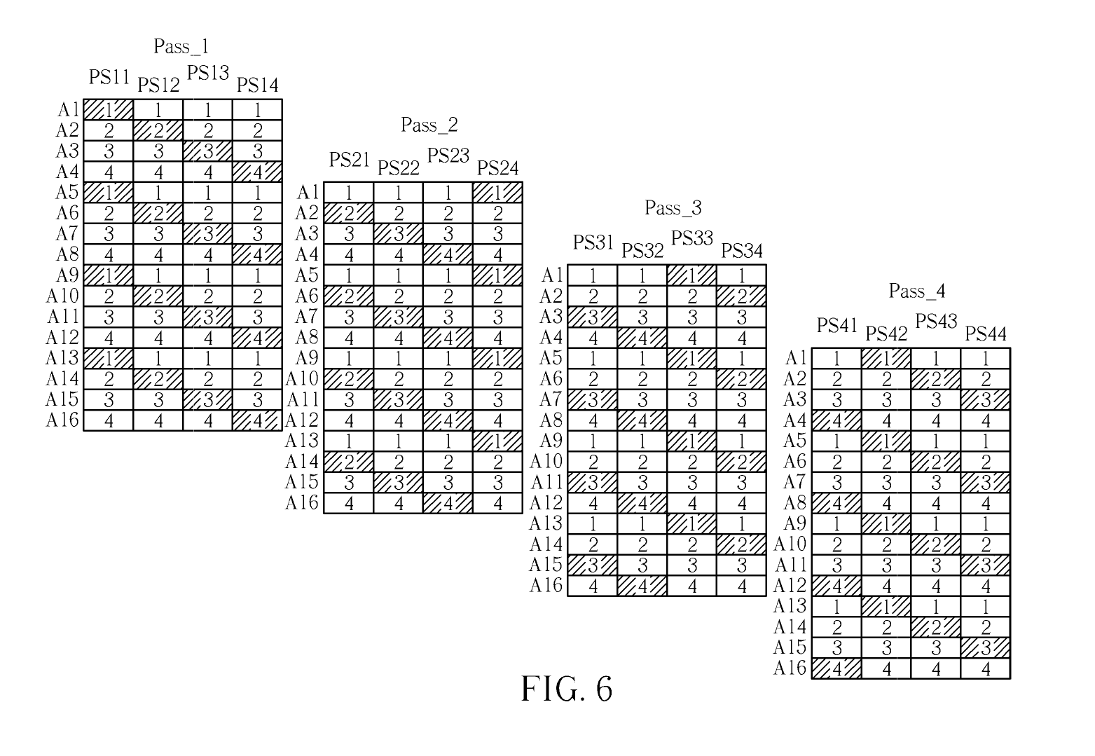

Please refer to FIG. 6. FIG. 6 is a diagram illustrating how to drive different nozzles at adjacent slice periods according to a second embodiment of the present invention. In this embodiment, M equals 4 and a 25% shingling mode with 600 dpi is used. Thus, printing of a certain area can be finished whenever four-pass printings pass through. As shown in FIG. 6, the four passes of printing are represented by Pass_1, Pass_2, Pass_3, and Pass_4, wherein each of the four passes of printing respectively includes four slice periods labeled by PS11-PS14, PS21-PS24, PS31-PS34, and PS41-PS44 respectively. After the print head completes one pass of printing, the print head is moved down a distance equaling one-fourth of the print head relative to its target object. The print area of the print head that the address lines A13-A16 correspond to during the first pass of printing Pass_1, the print area of the print head that the address lines A9-A12 correspond to during the second pass of printing Pass_2, the print area of the print head that the address lines A5-A8 correspond to during the third pass of printing Pass_3, and the print area of the print head that the address lines A1-A4 correspond to during the fourth pass of printing Pass_4 all correspond to the same print area of the target object. Due to M equaling 4, the address lines A1-A16 of the matrix 220 are divided into four groups. In this embodiment, all the nozzles related to the address lines A1, A5, A9, A13 are delimited into the first group, all the nozzles related to the address lines A2, A6, A10, and A14 are delimited into the second group, all the nozzles related to the address lines A3, A7, A11, and A15 are delimited into the third group, and all the nozzles related to the address lines A4, A8, A12, and A16 are delimited into the fourth group. If one-way printing (i.e., the target object is printed by the print head in a direction of from-left-to-right) is adopted, the nozzles belonging to the first group, the second group, the third group, and the fourth group may be driven in order during the slice periods PS11, PS12, PS13, and PS14, respectively, in the first pass of printing Pass_1 . In the second pass of printing Pass_2, the nozzles belonging to the second group, the third group, the fourth group, and the first group may be driven in order during the slice periods PS21, PS22, PS23, and PS24, respectively. In the third pass of printing Pass_3, the nozzles belonging to the third group, the fourth group, the first group, and the second group may be driven in order during the slice periods PS31, PS32, PS33, and PS34, respectively. In the fourth pass of printing Pass_4, the nozzles belonging to the fourth group, the first group, the second group, and the third group may be driven in order during the slice periods PS41, PS42, PS43, and PS44, respectively. In other words, the nozzles belonging to different groups are driven at adjacent slice periods. All the nozzles may be driven once after four (M=4) slice periods go by. If two-way printing (i.e., after the target object is printed by the print head in the direction of from-left-to-right, the print head is moved down a certain distance relative to the target object and then the target object is printed by the print head in the direction of from-right-to-left to complete printing according to this circulation) is adopted, the driving method of each slice period in the first pass of printing Pass_1 and the third pass of printing Pass_3 is the same as the driving method of the one-way printing stated above. In the second pass of printing Pass_2, however, the nozzles belonging to the first group, the fourth group, the third group, and the second group are driven in order during the slice periods PS24, PS23, PS22, and PS21, respectively. In the fourth pass of printing Pass_4, the nozzles belonging to the third group, the second group, the first group, and the fourth group are driven in order during the slice periods PS44, PS43, PS42, and PS41, respectively.

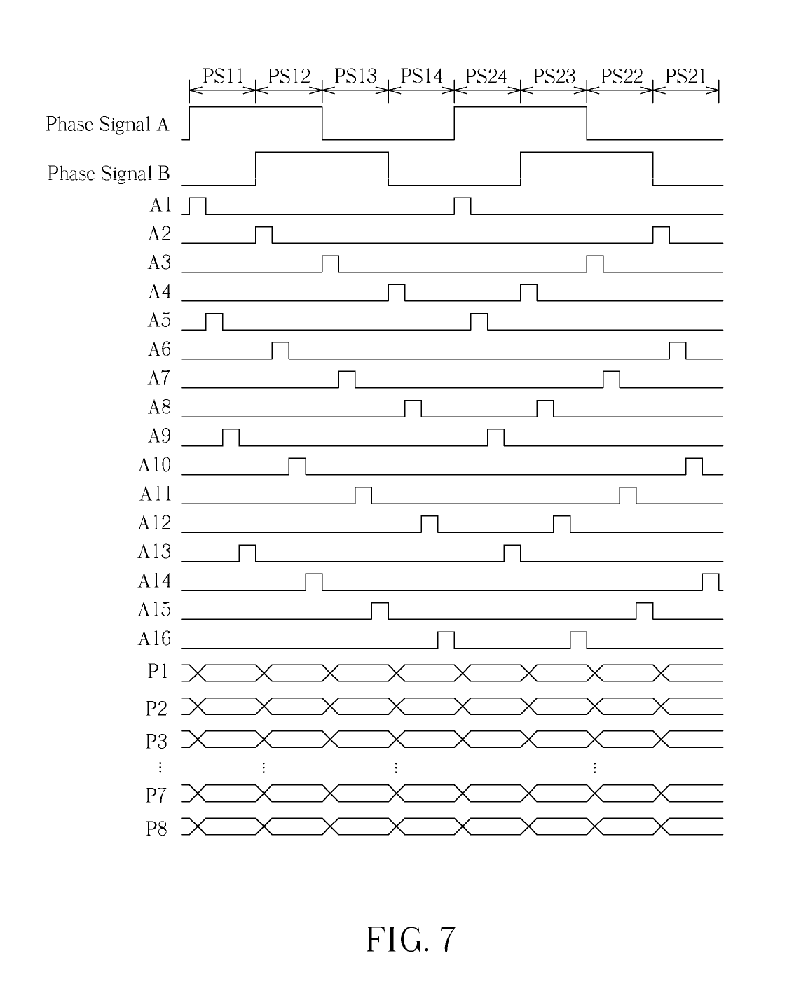

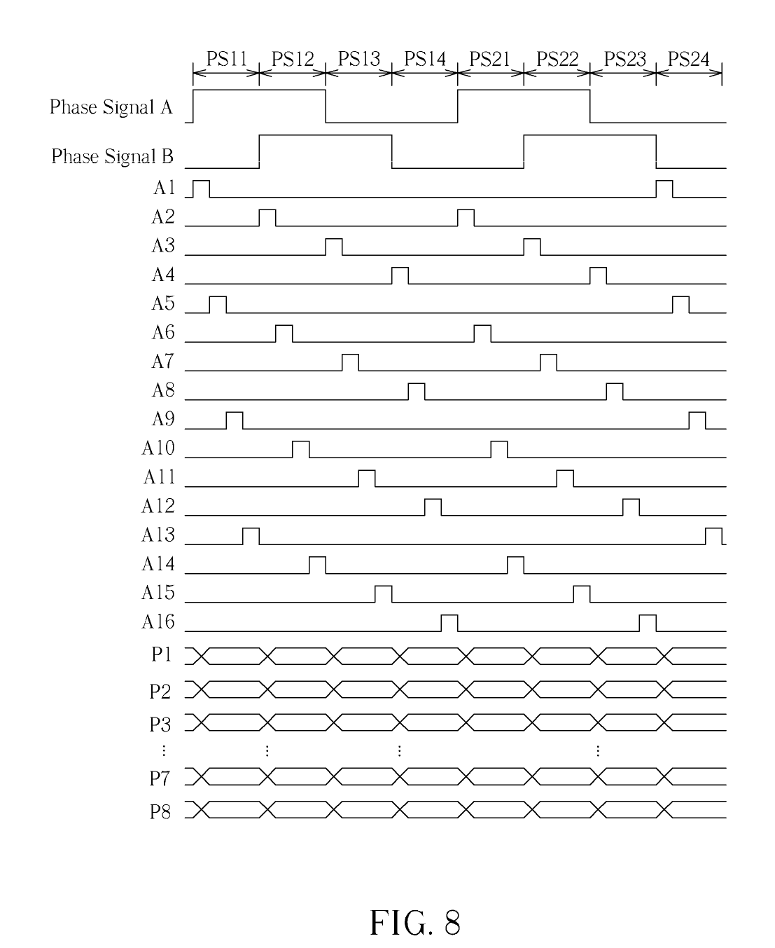

Please refer to FIG. 7 and FIG. 8. FIG. 7 and FIG. 8 are, respectively, the timing diagrams showing the examples of the driving sequence of the preceding two passes of printing shown in FIG. 6. There are sixteen address lines A1-A16 and eight power lines P1-P8, wherein the address lines A1-A16 are enabled in order while the power lines P1-P8 are enabled depending on print demands. FIG. 7 shows the driving sequence of the address lines during the preceding eight slice periods PS11-PS14 and PS24-PS21 when the two-way printing is adopted. That is, in the first pass of printing Pass_1, the target object is printed in the direction of from-left-to-right by the print head to sequentially complete the slice periods PS11, PS12, PS13, and PS14. Then the print head is moved down a distance equaling one-fourth of the print head relative to its target object. After that, the target object is printed in the direction of from-right-to-left by the print head to sequentially complete the slice periods PS24, PS23, PS22, and PS21 in the second pass of printing Pass_2. FIG. 8 shows the driving sequence of the address lines during the preceding eight slice periods PS11-PS14 and PS21-PS24 when the one-way printing is adopted. Compared with the timing diagram shown in FIG. 1, there are sixteen address lines of nozzles that need to be enabled during each slice period in FIG. 1 while there are only four address lines of nozzles that need to be enabled during each slice period in FIG. 7 and FIG. 8. For example, assuming that the time of each slice period in FIG. 1 equals T, thus the time of each slice period in FIG. 7 and FIG. 8 can be shortened to T/4.

Please note that the print controlling method disclosed in the present invention can be used in a shingling mode, but this should not be considered as a limitation of the scope of the present invention. In addition, the number M is not fixed and can be approximately adjusted by those skilled in the art without departing from the spirit of the present invention.

The abovementioned embodiments are presented merely for describing the present invention, and in no way should be considered to be limitations of the scope of the present invention. In summary, the present invention provides a print controlling method applied to a printer, in which the nozzles belonging to different groups are driven during adjacent slice periods. Therefore, only a part of address lines of nozzles need to be enabled during each slice period, which can shorten the time of the slice period to achieve goals of saving bandwidth, improving print speed, and reducing system workload. Furthermore, when the number of nozzles is increased, the method disclosed in the present invention can bring its effect into full play.

Those skilled in the art will readily observe that numerous modifications and alterations of the device and method may be made while retaining the teachings of the invention.

What is claimed is:

1. A print controlling method applied to a printer, the printer comprising a plurality of nozzles, each of the nozzles being driven by one of a plurality of address lines, the print controlling method comprising:
dividing the plurality of address lines into M groups, wherein M is a positive integer; and
enabling the address lines belonging to one of the M groups to drive the corresponding nozzles during each slice period;
wherein the address lines enabled at adjacent slice periods correspond to different groups.

2. The print controlling method of claim 1, wherein the address lines corresponding to all the nozzles may be enabled once after M slice periods go by.

3. The print controlling method of claim 1, wherein the printer comprises a thermal bubble printer.

4. The print controlling method of claim 1, being used in a shingling mode.

5. The print controlling method of claim 4, wherein M equals 2 and the method is used in a 50% shingling mode.

6. The print controlling method of claim 4, wherein M equals 4 and the method is used in a 25% shingling mode.

7. A printer, comprising:
a plurality of nozzles;
a nozzle driving circuit, comprising a plurality of address lines, each of the address lines being respectively coupled to one of the nozzles for driving the corresponding nozzle; and
an ink controller, coupled to the address lines of the nozzle driving circuit and the nozzles, the ink controller comprising:
a group allocating module, for dividing the address lines into M groups, wherein M is a positive integer; and
a group controlling module, for controlling the nozzle driving circuit to enable the address lines belonging to one of the M groups to drive the corresponding nozzles during each slice period;
wherein the address lines enabled at adjacent slice periods correspond to different groups.

8. The printer of claim 7, wherein the address lines corresponding to all the nozzles may be enabled once after M slice periods go by.

9. The printer of claim 7, wherein the printer comprises a thermal bubble printer.

10. The printer of claim 7, being used in a shingling mode.

11. The printer of claim 10, wherein M equals 2 and the printer is used in a 50% shingling mode.

12. The printer of claim 10, wherein M equals 4 and the printer is used in a 25% shingling mode.
